(19) United States
(12) Patent Application Publication
(10) Pub. No.: US 2013/0067871 A1
(43) Pub. Date: Mar. 21, 2013

(54) COMBINATION REMOVABLE TRACTION CONTROL SADDLE COVER, ACCESSORY TRACTION CONTROL & SADDLE FITTING SHIM SYSTEM FOR MOUNTABLE SPORTS RIDING EQUIPMENT

(71) Applicant: LeeAnn Morgan, Manhattan Beach, CA (US)

(72) Inventor: LeeAnn Morgan, Manhattan Beach, CA (US)

(21) Appl. No.: 13/565,067

(22) Filed: Aug. 2, 2012

Related U.S. Application Data
(63) Continuation-in-part of application No. 12/983,625, filed on Jan. 3, 2011, now abandoned.

(51) Int. Cl. B68C 1/02

(52) U.S. Cl. 54/44.1

(57) ABSTRACT

A combination removable, protective saddle cover and traction control accessory system is provided. The combination system comprises 1-10 flexible, adhesive-backed panels that form a protective layer over the saddle and also increase grip for the rider. The system's individual parts are applied to create a protective, decorative, non-slip interface between a rider and a saddle or other mounted sports riding equipment. The invention also adheres to the non-visible undersides of the saddle and serve as a set of custom saddle-fitting shims, to eliminate the pain of an ill-fitting saddle and providing better anatomical fit between the saddle and the horse.

### CROSS-REFERENCE TO RELATED APPLICATIONS

This Continuation-In-Part Application references and claims benefit of U.S. Non-Provisional Application 12/983,625 (Morgan).

This application repeats a substantial portion of prior Non-Provisional Application No. 12/983,625, filed Jan. 3, 2011. It discloses and claims additional matter not presented in the prior application. This application names the same inventor (Morgan) named in the prior, co-pending application. Therefore it constitutes a Continuation-in-Part of the prior application.

### BACKGROUND OF THE INVENTION

### Field of Endeavour: Mounted Riding Sports Equipment

This combination invention protects a riding saddle and increases the gripping strength of a rider's seat and legs upon a mounted moving animal or other object. Its other utility is a set of saddle fitting shims. The invention encompassed, claimed and taught herein is to be classified as a Sporting Goods Accessory device relating to equestrian saddles and other mounted types of sports riding equipment. Applicable MPEP Classification Codes: Class D21 (Sports Equipment)/Sub-Class: 698 (Sports Equipment)/Sub-Class D29 (Safety & Protection Equipment)/Sub-Class 771: Element, Attachment, Accessory.

In riding any mounted object using a saddle, riding safety, comfort and coordination largely depend on the rider's grip upon the saddle of the animal. Conventional riding saddles, made from leather, synthetic leather, or nylon-composite fabric (Wintec Saddle Company), while durable, are not inherently safe and often do not afford the rider the best traction needed for optimal control. Constant and prolonged use of the rider's lower body muscles requires extensive strength, coordination and endurance. This causes undue fatigue, creating safety risks, major bodily and head injury from rider falls and other injuries.

Saddles are also very expensive pieces of equipment in sport riding. The surface areas contacting the rider eventually wear out and are costly to replace.

In the same manner as any removable high-tack grip for any hand-held sporting goods equipment such as a tennis racquet, baseball bat or golf club grip, the claimed invention provides increased grip for the seat and legs upon any riding saddle that is attached to a mountable, moving object.

Lastly, the removable combination saddle cover and fraction control accessory system of flexible, form-fitting panels also solves the problem of ill-fitting saddles causing back pain for the horse. The invention is also attachable to any or all non-visible surfaces of an equestrian saddle to conform to the unique backs of individual horses. The invention thus serves a third purpose as a set of custom, saddle-fitting shims to eliminate the problem of an ill-fitting, pain-causing saddle for individual horses.

To date, there exists no such accessory device to extend the useful life of a riding saddle, to serve the lower parts of a rider's body in an injury-repellant, grip-enhancing manner, and also to serve as a system of saddle fitting shims to eliminate saddle pain for the horse.

### BRIEF SUMMARY OF THE INVENTION

The present invention combines a removable, form-fitting, protective, grip-increasing saddle cover with a detachable accessory system of saddle-gripping panels for riding saddles and other mountable sports equipment. The invention is comprised of up to 10 form-fitting, removable panels, sized and shaped to conform to the surfaces of mountable riding equipment, improving the rider's grip and safety, and adding a synthetic layer of protection to extend the life of the saddle.

The removable saddle-shaped cover components of the invention consist of several flexible, grip-improving pieces sized and shaped to adhere to and fully cover the whole surface of the saddle. These pieces can serve either as the protective base-layer of the combination invention, or they can be used alone as a stick-on saddle cover.

The traction-control accessory component of the invention also has several panels to serve the rider. These smaller shapes can be attached either to the saddle cover for added fraction, or they can be used by themselves and adhered directly to the seat and leg portions of the saddle.

Depending on the weather or rider's purpose, the rider can apply any or all parts of the invention.

All parts of the invention are made of any suitable protective, flexible, form-fitting, traction-enhancing manufactured gel, rubber, or foam-based material that can be removed, repositioned, cleaned and re-applied. The underside of each piece has a pressure-sensitive adhesive or hydrophilic property, with a film release liner.

In one embodiment, the system's panels are applied to an Equestrian saddle, where the saddle's surface contacts the seat, crotch, knee, and calf areas of the rider's body.

### BRIEF DESCRIPTION OF THE DRAWINGS: FIGS. 1 & 2

The above features of the present invention become more apparent by reference to the drawings. According to one embodiment of the present invention:

FIG. 1 illustrates the Removable Saddle Cover component of the invention's 4 separate panels for the seat, crotch, and the two leg portions of an English saddle.

FIGS. 1a-1d are applied to an English-type riding saddle. The clear gel, form-fitting saddle cover comprises four pieces. These cover the left leg flap (FIG. 1a), the front pommel (FIG. 1b), the right leg flap (FIG. 1c), and the back cantle (FIG. 1d) of the saddle.

FIG. 2 illustrates 5 smaller, removable traction control panels (FIGS. 2a-2e) of the combination invention, which can apply either to the saddle cover of FIG. 1, or directly onto the leg and seat portions of a saddle proper.

### DETAILED DESCRIPTION OF THE INVENTION

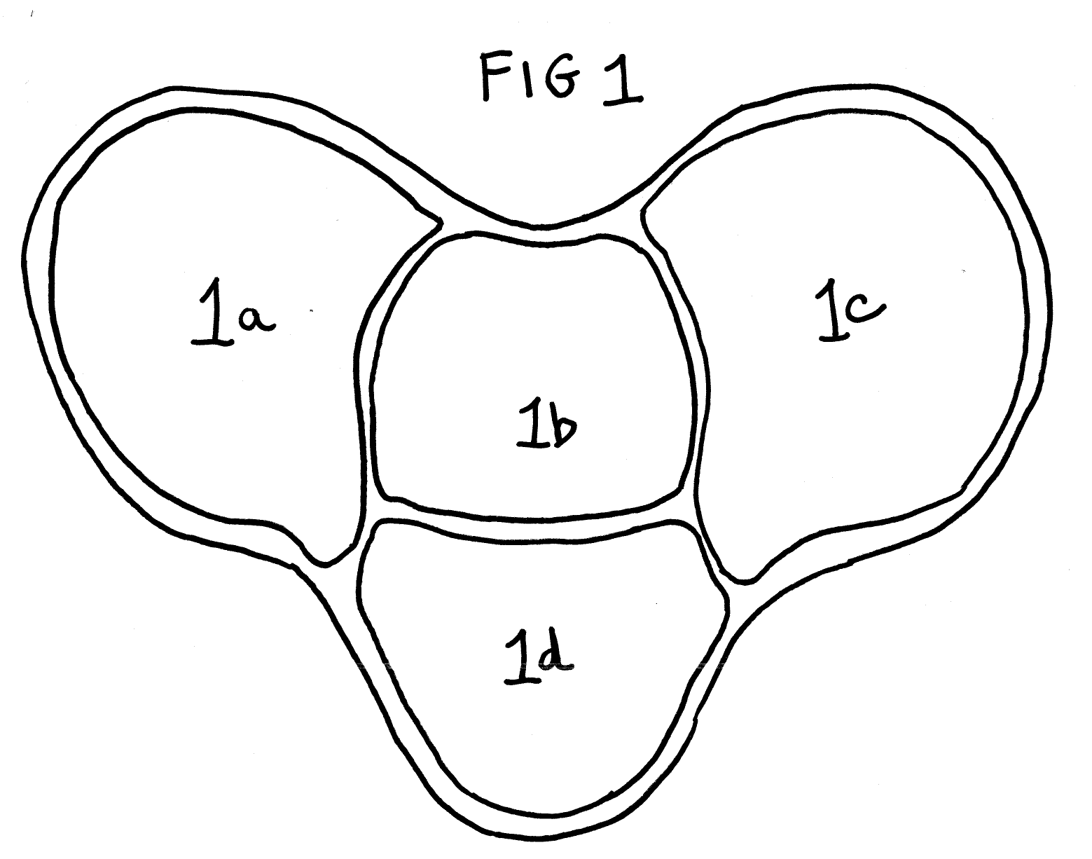

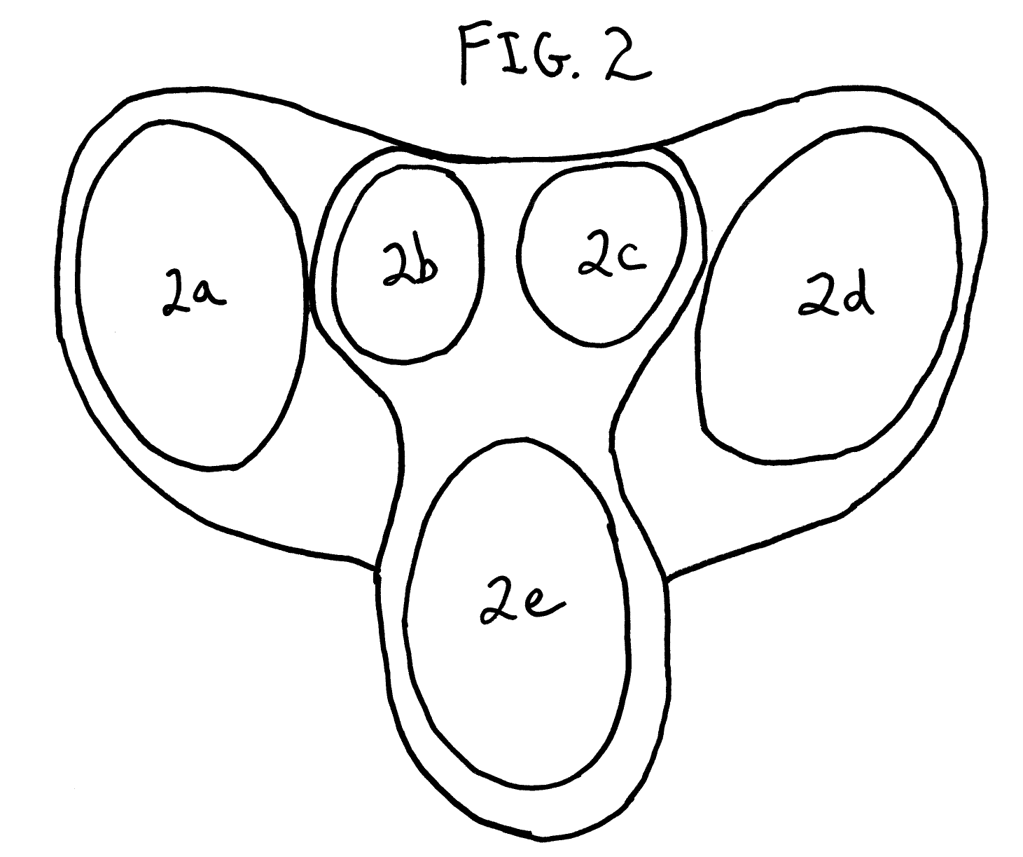

As shown in FIGS. 1 and 2, the individual panels of the combination removable saddle cover (FIG. 1) and traction control (grip-improving) accessory panels (FIG. 2) are sized and shaped according to one embodiment, an English-type equestrian Saddle. The invention can comprise up to 10 panels sized and shaped to cover the Saddle and provide increased accessory grip for the rider.

The effective sizes for each of the panels in the invention varies. The size of each saddle cover component (FIG. 1) is obviously limited to the surface area measurements of the saddle.

The grip-enhancing (traction control) accessory panels of the combination invention (FIG. 2) can vary in size with the body part of the rider.

In the current embodiment, the size and shape of the traction control accessory panels (FIGS. 2a, 2d, and 2e), attached to the sides and seat of the saddle cover of FIG. 1 is an oval-shape, approximately 9″×12″ in size. These dimensions are adequate for use by a rider ranging from 30 to 250 pounds in weight.

The 2 slightly smaller oval shapes (FIGS. 2b and 2c) are approximately 5″×7″ in size and apply to the front pommel portions of the saddle which contact the upper thighs of the rider.

The base material for each part of the combination invention has a minimum effective thickness of 3-5 millimeters (mm) and a maximum of 5-10 mm.

The material composition of the invention can be any suitable high-tack, flexible, traction-causing synthetic compound or copolymer. Any method of manufacture can be used—whether by die-cutting, heat-molding, poured and cured, pressure-extruded, steel-cast or compression formed.

The underside of each removable part has a non-permanent, pressure-sensitive adhesive action, protected before use by a release-backing of paper or film.

The present embodiment relates to English type Equestrian Saddles. However, it is to be understood that the invention can be used on the surface of any type of riding saddle, including personal motor sports vehicle saddles, such as a motorcycle, or any other mounted and ridden object.

Riding saddles are expensive. Maintaining sustained grip for extended time periods during riding is difficult and makes the rider prone to injury. The novel invention of a removable, form-fitting, adhesive-backed saddle cover combined with detachable traction control accessory panels solves several problems at once.

### CONCLUSION

The preceding descriptions of the inventive combination removable saddle cover and fraction control system have been presented with reference to the Equestrian Saddle embodiment of the current invention. However, workers and craftsmen skilled in the art and technology to which this invention pertains will appreciate that alterations and changes to the described embodiment in response to market demands may be practiced without meaningfully departing from the principle, spirit, and scope of this invention. Accordingly, the foregoing description should not be read as pertaining only to the precise embodiment described and as illustrated in the photograph, but rather should be interpreted as consistent with and as support for the claims stated at the beginning of this Application, which are to have their fullest and fairest scope.

1. A removable, combination saddle cover & traction control system of flexible, detachable panels for equestrian saddles and other mountable sports riding equipment is claimed, comprising 1-10 panels, which fully cover and conform to the shape of the saddle, and which provide a grip-inducing interface between the rider's lower body and the saddle.

2. The removable saddle cover & traction control system of claim 1, wherein the rider's contact surface of each panel has a grip-inducing action.

3. The removable combination saddle cover & traction control system of claim 1, wherein the underside of each panel has a non-permanent, pressure-sensitive adhesive or hydrophilic property, enabling its adherence to the saddle surface.

4. The removable combination saddle cover and traction control accessory system of claim 1, wherein the system is also attachable to any or all non-visible surfaces of equestrian saddles contacting the unique back surface anatomies of each horse; thus serving as a set of saddle-fitting shims to remedy an ill-fitting, pain-causing saddle to a specific horse.
